(19) United States
(12) Patent Application Publication
(10) Pub. No.: US 2018/0160087 A1
(43) Pub. Date: Jun. 7, 2018

(54) HUD IMAGE OPTIMIZATION THROUGH SOFTWARE CONTROL OF DISPLAYED GRAPHICS

(71) Applicant: Panasonic Automotive Systems Company of America, Division of Panasonic Corporation of North America, Peachtree City, GA (US)

(72) Inventors: WALTER JOSEPH NILL, DAVISON, MI (US); DAVID K. LAMBERT, STERLING HEIGHTS, MI (US); DEREK DIDIER, SNELLVILLE, GA (US)

(21) Appl. No.: 15/829,695

(22) Filed: Dec. 1, 2017

Related U.S. Application Data
(60) Provisional application No. 62/428,750, filed on Dec. 1, 2016.

(51) Int. Cl. H04N 9/31; B60K 35/00; B60R 1/00

(52) U.S. Cl. CPC H04N 9/3194; H04N 9/3185; B60K 35/00; B60R 2300/304; B60K 2350/2052; B60K 2350/2013; B60R 2300/205; B60R 1/00

(57) ABSTRACT

A head up display calibration arrangement includes a substrate associated with a windshield. The substrate has a test pattern. A head up display module projects a test display in association with the windshield. The test display at least partially overlaps the test pattern. The test display is projected dependent upon at least one projection parameter value. A camera captures an image of the test display and the test pattern, and transmits an image signal dependent upon the captured image. An electronic processor is communicatively coupled to each of the camera and the head up display module. The processor receives the image signal and determines from the image signal a positional relationship between the test display and the test pattern within the captured image. The processor modifies the projection parameter value dependent upon the determined positional relationship between the test display and the test pattern within the captured image.

### CROSS-REFERENCED TO RELATED APPLICATIONS

This application claims benefit of U.S. Provisional Application No. 62/428,750 filed on Dec. 1, 2016, which the disclosure of which is hereby incorporated by reference in its entirety for all purposes.

### FIELD OF THE INVENTION

The disclosure relates to the field of automotive displays, and, more particularly, to a Head Up Display (HUD) in a vehicle.

### BACKGROUND OF THE INVENTION

The image from a HUD often contains distortion in that the image is not rectilinear. The image may appear to have a keystone, smile, frown or trapezoidal appearance due to errors in the HUD or in the vehicle build. These errors are very difficult to control in actual practice, which can be due to variations in the individual body builds, windshields, installations of the HUD into the dashboard, and HUD optics, as well as other variances.

### SUMMARY

The present invention may enable a vehicle manufacturer to calibrate or “dial in” a virtual image produced by a HUD after the HUD has been installed in the vehicle and after the vehicle build has been completed. The calibration may be performed through software control of the virtual image at the end-of-line (EOL) test or at a similar station (such as a service bay) after the vehicle has been built. At this station, a target grid or other target pattern may be provided at the designed projection distance for the HUD optics. A camera may be placed in the eyebox, and the HUD may be activated to display an image that at least partially corresponds with the target pattern. That is, the image produced by the HUD, which may be a matrix of dots or grid lines, for example, is intended to be displayed at predetermined locations relative to the target pattern. For example, a matrix of dots may be displayed at locations intended to coincide with or overlay a matrix of target dots. Alternatively, each of a matrix of dots may be displayed at a location intended to coincide with the center of a respective square within a grid. As another alternative, a grid may be displayed that is intended to coincide with or overlay a target grid. At locations where the camera determines that the projected display and the target pattern do not match, or are misaligned, the controller adjusts parameter values of the HUD display image to match or better align with the target pattern. The adjusted parameter values may be saved in the HUD memory. The vehicle may then be deemed to have passed the HUD test with the HUD image being better aligned with the test pattern.

In one embodiment, the invention comprises a head up display calibration arrangement including a substrate associated with a windshield. The substrate has a test pattern. A head up display module projects a test display in association with the windshield. The test display at least partially overlaps the test pattern. The test display is projected dependent upon at least one projection parameter value. A camera captures an image of the test display and the test pattern, and transmits an image signal dependent upon the captured image. An electronic processor is communicatively coupled to each of the camera and the head up display module. The processor receives the image signal and determines from the image signal a positional relationship between the test display and the test pattern within the captured image. The processor modifies the projection parameter value dependent upon the determined positional relationship between the test display and the test pattern within the captured image.

In another embodiment, the invention comprises a display method for a vehicle, including placing a substrate in association with a windshield of the vehicle. The substrate has a test pattern. A test display is projected such that the test display at least partially overlaps the test pattern. The test display is projected dependent upon at least one projection parameter value. An image of the test display and the test pattern is captured. A positional relationship between the test display and the test pattern is determined from the image. The projection parameter value is modified dependent upon the determined positional relationship between the test display and the test pattern.

In yet another embodiment, the invention includes a head up display installation method for a vehicle, including providing a test pattern at the position of the virtual image. The test pattern includes a first element. A test display is projected onto the windshield to create the virtual image. The test display includes a second element. The test display is projected dependent upon at least one projection parameter value. An image of the test display and the test pattern is captured. A positional relationship between the first element and the second element is determined from the image. The projection parameter value is modified dependent upon the determined positional relationship between the first element and the second element.

The invention may have the advantage that the head up display has less distortion due to the physical variations from vehicle to vehicle.

### BRIEF DESCRIPTION OF THE DRAWINGS

A better understanding of the present invention will be had upon reference to the following description in conjunction with the accompanying drawings.

FIG. 1 is a block diagram of one embodiment of a vehicle of the present invention including a Head Up Display arrangement of the invention.

FIG. 2a is a schematic view of an example embodiment of a HUD display superimposed on a test pattern before calibration according to the invention.

FIG. 2b is a schematic view of an example embodiment of a HUD display superimposed on the test pattern of FIG. 2a after calibration according to the invention.

FIG. 3 is a schematic diagram of another embodiment of a vehicle of the present invention including a Head Up Display arrangement of the invention.

FIG. 4 is a flow chart of one embodiment of a head up display installation method for a motor vehicle.

### DETAILED DESCRIPTION OF THE PREFERRED EMBODIMENTS

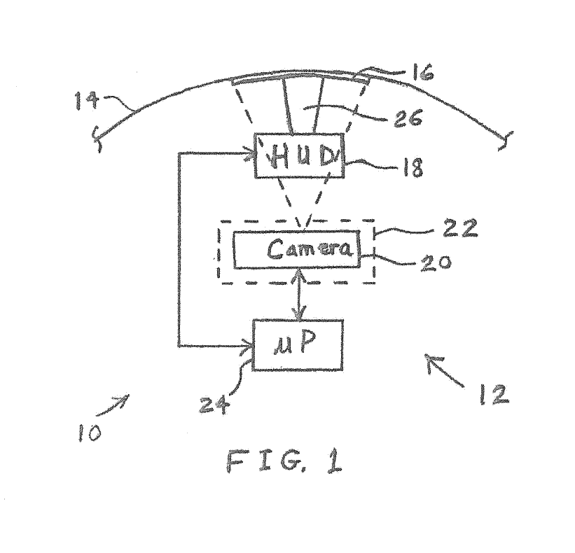

FIG. 1 illustrates one embodiment of a motor vehicle 10 of the present invention including a HUD arrangement 12 of the invention. HUD arrangement 12 includes a windshield 14, a substrate 16 with a test pattern printed thereon, a head up display module 18, a camera 20 disposed within an eyebox 22 and focused on the virtual image, and an electronic processor 24. Processor 24 may be communicatively coupled to each of camera 20 and HUD 18. HUD 18 may be a conventional HUD utilizing a windshield as a combiner or a combiner HUD where the combiner is a separate element contained within the device.

Substrate 16 may be placed at a predetermined location in accordance with the virtual image requirements. Substrate 16 contains the test pattern printed thereon facing inwardly toward camera 20. Substrate 16 is shown as having substantial thickness in FIG. 1 for ease of illustration. However, it is to be understood that substrate 16 may be paper-thin, such as a sheet of plastic.

During use, processor 24 causes HUD module 18 to project a test display onto the test pattern of substrate 16, as indicated at 26. The test display is intended to have a predetermined spacing or alignment relative to the test pattern, assuming that there are no variances in vehicle 10 that would cause the test display to be misaligned, offset, or otherwise displayed at an incorrect location.

Processor 24 then causes camera 20 to capture an image of the test display and the test pattern on which the test display is projected. The captured image is transmitted from camera 20 to processor 24, and processor 24 determines, by analyzing the captured image, the locations of any misalignments or offsets of the test display relative to the test pattern, and the degree of such misalignments or offsets. Processor 24 may then calculate a new set of parameter values to be used within HUD 18 in projecting the display in order to correct the misalignments or offsets. Processor 24 may implement the new set of parameter values in conjunction with HUD 18 to project a correct display onto the test pattern. Camera 20 may again capture an image of the display projected onto the test pattern and processor 24 may analyze the corrected image to verify that the misalignments or offsets have been eliminated to the extent possible. If not, processor may calculate another set of new parameter values, and the process may be repeated as many times as desired to reduce the misalignments or offsets as much as possible.

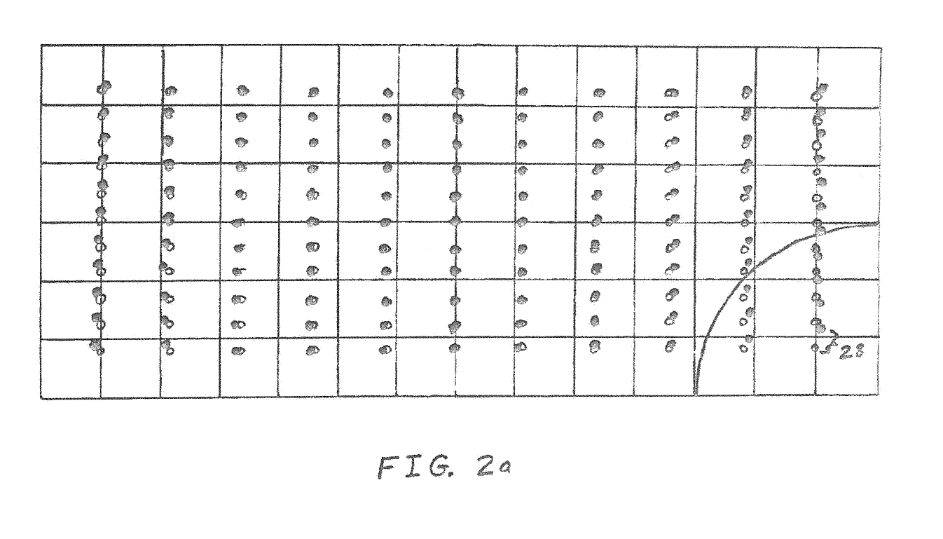

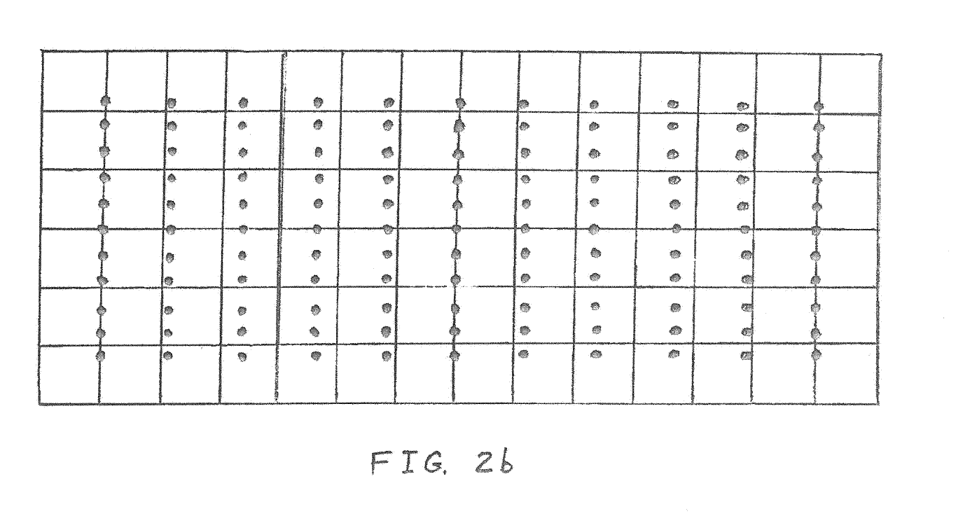

FIG. 2a illustrates an example test display including a matrix of solid dots projected onto a test pattern including a matrix of small circles and a grid of horizontal and vertical lines. The matrix of solid dots is projected such that each dot should be coincident with and superimposed on a respective one of the circles. As best shown in the quarter circle-shaped area in the lower right-hand corner of the grid, many of the dots are offset from their respective target circle. For example, an offset 28 represents a distance between a dot and its target circle.

FIG. 2b illustrates the test display and test pattern of FIG. 2a after the HUD projection parameter values have been adjusted by processor 24 in order to better align each dot with its respective target dot. As is evident in FIG. 2b, each dot may be at least partially overlapped or at least partially superimposed on its respective target circle.

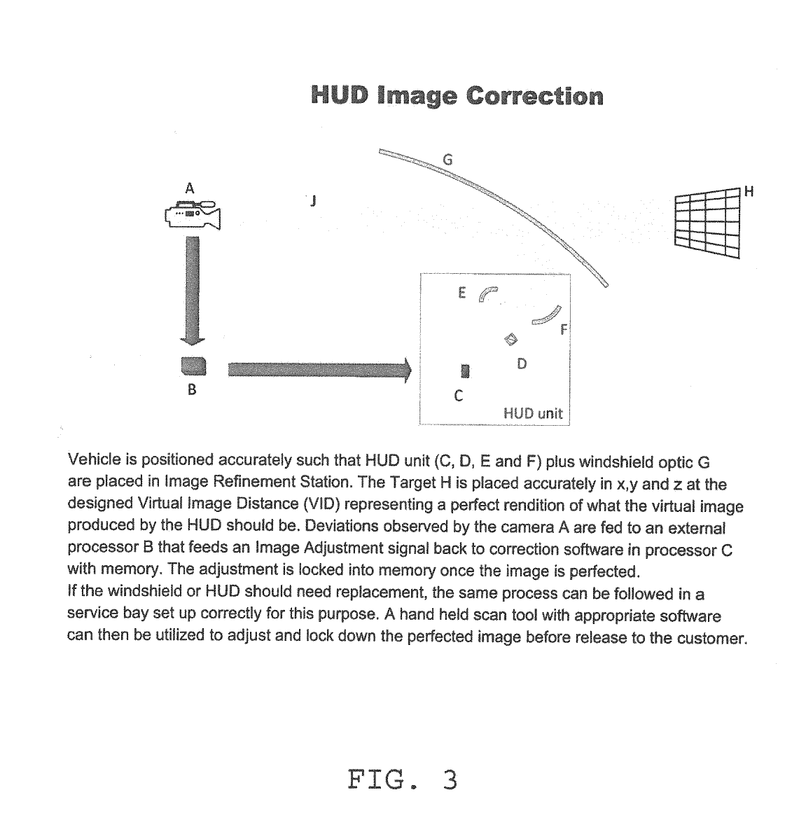

FIG. 3 illustrates another embodiment of a motor vehicle of the present invention including a HUD arrangement of the invention. The vehicle is positioned accurately such that the HUD unit (C, D, E and F) and the windshield optic G are placed in an Image Refinement Station. The Target H is placed accurately in three dimensions (x, y, z) at the designed Virtual Image Distance (VID) representing a rendition of what the virtual image produced by the HUD should be. Deviations captured by camera A are fed to an external processor B that feeds an Image Adjustment signal back to correction software in processor C with memory. The adjustment is locked into memory once the image is perfected.

If the windshield or the HUD should need replacement, the same process may be followed in a service bay set up correctly for this purpose. A hand-held scan tool with appropriate software can then be utilized to adjust and lock down the perfected image before release to the customer.

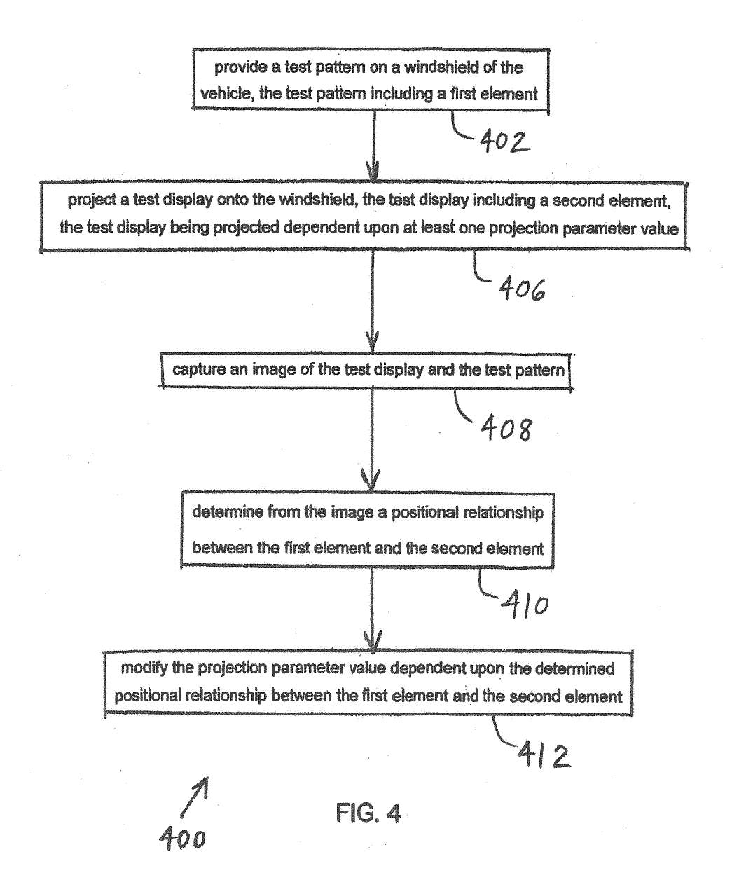

FIG. 4 illustrates one embodiment of a head up display installation method 400 for a motor vehicle. In a first step 402, a test pattern is provided on a windshield of the vehicle. The test pattern includes a first element. For example, a substrate 16 with a test pattern printed thereon may be placed on windshield 14 as shown in FIG. 1, facing inwardly toward camera 20. The test pattern may include first elements in the form of small circles arranged in a matrix, as shown in FIG. 2a.

Next, in step 404, a test display is projected onto the windshield. The test display includes a second element. The test display is projected dependent upon at least one projection parameter value. For example, as shown in FIG. 2a, a test display including second elements in the form of solid dots arranged in a matrix may be projected onto the test pattern that is on substrate 16 on windshield 14. The projection of the test display may be dependent upon HUD projection parameter values, such as mirror orientations, mirror positions in three-dimensional space, and image mapping parameters, for example.

In a next step 406, an image of the test display and the test pattern is captured. For example, processor 24 may cause camera 20 to capture an image of a test display and a test pattern on which the test display is projected.

In step 408, a positional relationship between the first element and the second element is determined from the image. For example, processor 24 may analyze the image captured by camera 20 and determine an offset 28 distance between a dot and its target circle, as shown in FIG. 2a.

In a final step 410, the projection parameter value is modified dependent upon the determined positional relationship between the first element and the second element. For example, processor 24 may modify a projection parameter value in order to reduce the offset 28 distance between the dot and its target circle.

The foregoing description may refer to “vehicle”, “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A Head Up Display calibration arrangement, comprising:
a combiner (windshield or separate combiner element);
a target substrate associated with the vehicle, the substrate having a predetermined orientation and shape based upon the optical design yielding the test pattern;
a Head Up Display module configured to project a test display associated with the combiner, the test display at least partially overlapping the test pattern, the test display being projected dependent upon at least one projection parameter value;
a camera configured to:
capture an image of the test display and the test pattern; and
transmit an image signal dependent upon the captured image; and
an electronic processor communicatively coupled to each of the camera and the head up display module, the processor being configured to:
receive the image signal and to determine from the image signal a positional relationship between the test display and the test pattern within the captured image; and
modify the projection parameter value dependent upon the determined positional relationship between the test display and the test pattern within the captured image.

2. The arrangement of claim 1 wherein the test pattern is visible.

3. The arrangement of claim 1 wherein the test pattern appears on the substrate.

4. The arrangement of claim 1 wherein the substrate is placed at the design Virtual Image Distance (VID) precisely as specified in the HUD Optical Design; alternately, this distance could be adjusted according to the optical design parameters.

5. The arrangement of claim 1 wherein the substrate is positioned so that the camera may superimpose the two images.

6. The arrangement of claim 1 wherein the processor is configured to modify the projection parameter value to reduce an offset or misalignment between the test display and the test pattern.

7. The arrangement of claim 1 wherein the head up display module is configured to project the test display dependent upon the modified projection parameter value.

8. The arrangement of claim 1 wherein the processor is configured to:
verify that an offset or misalignment between the test display and the test pattern is reduced by use of the modified projection parameter value; and
store the modified projection parameter value in memory for future use.

9. The arrangement of claim 1 wherein the test pattern comprises a first matrix of rows and columns of first elements, and the test display comprises a second matrix of rows and columns of second elements, the first matrix haying a same number of rows as the second matrix, and a same number of columns as the second matrix.

10. The arrangement of claim 1 wherein the substrate comprises a sheet of transparent plastic.

11. A display method for a vehicle, the method comprising:
placing a substrate in relative position to a combiner (windshield) of the vehicle, the substrate having a test pattern;
projecting a test display such that the test display at least partially overlaps the test pattern, the test display being projected dependent upon at least one projection parameter value;
capturing an image of the test display and the test pattern;
determining from the image a positional relationship between the test display and the test pattern; and
modifying the projection parameter value dependent upon the determined positional relationship between the test display and the test pattern.

12. The method of claim 11 wherein the test pattern is visible.

13. The method of claim 11 wherein the test pattern is printed on the substrate.

14. The method of claim 11 wherein the substrate is positioned relative to the combiner (windshield)

15. The method of claim 11 wherein the modifying step includes modifying the projection parameter value to reduce an offset or misalignment between the test display and the test pattern.

16. The method of claim 11 wherein the test display is projected dependent upon the modified projection parameter value.

17. The method of claim 11 further comprising:
verifying that an offset or misalignment between the test display and the test pattern is reduced by use of the modified projection parameter value; and
storing the modified projection parameter value in memory for future use.

18. The method of claim 11 wherein the test pattern comprises a first matrix of rows and columns of first elements, and the test display comprises a second matrix of rows and columns of second elements, the first matrix having a same number of rows as the second matrix, and a same number of columns as the second matrix.

19. The method of claim 11 wherein the substrate comprises a sheet of transparent plastic.

20. A head up display installation method for a motor vehicle, the method comprising:
providing a test pattern on a windshield of the vehicle, the test pattern including a first element;
projecting a test display onto the windshield, the test display including a second element, the test display being projected dependent upon at least one projection parameter value;
capturing an image of the test display and the test pattern;
determining from the image a positional relationship between the first element and the second element; and
modifying the projection parameter value dependent upon the determined positional relationship between the first element and the second element.

21. The method of claim 20 wherein the test pattern includes a plurality of first elements arranged in a plurality of rows and a plurality of columns, the test display including a plurality of second elements arranged in a plurality of rows and a plurality of columns, the determining step comprises ascertaining a misalignment or offset between each of the first elements and a respective one of the second elements.
